(19) United States
(12) Patent Application Publication
(10) Pub. No.: US 2003/0123108 A1
(43) Pub. Date: Jul. 3, 2003

(54) Method and related apparatus for compensating light inhomogeneity of a light-distributing device of a scanner

(76) Inventors: Hai-Jui Lin, Yun-Lin Hsien (TW); Hsing-Hung Lin, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,050

(22) Filed: Jun. 4, 2002

(30) Foreign Application Priority Data
Dec. 28, 2001 (TW) 090133002

(51) Int. Cl. H04N 1/46

(52) U.S. Cl. 358/504

(57) ABSTRACT

A method for calibrating an image generated from a scanner when scanning a document is provided. The scanner includes a housing having a transparent platform positioned on the housing for placing the document, a light-distributing device positioned above the transparent platform for projecting light on the document, a track positioned inside the housing parallel with a scanning direction of the scanner, and a scanning module movably positioned on the track for sensing the light passing through the document and generating a corresponding scan signal. The method includes amplifying or decaying the scan signal generated from the scanning module according to a position of the scanning module located on the track when the scanning module slides along the track to scan the document.

### BACKGROUND OF INVENTION

1. Field of the Invention

The invention relates to a scanner, and more particularly, to a method and related apparatus for compensating light inhomogeneity of a light-distributing device of a scanner.

2. Description of the Prior Art

Owing to the rapid development of digital image processing systems, digital information can be displayed and transmitted in a high-speed and low-cost way. Thus, the demand for scanners used for transforming image information to digital information has increased recently. For example, a transmissive scanner, a type of optical scanner, is used to scan a transparent document such as a projection transparency. The transmissive scanner transforms the image information of the transparent document into digital information by projecting light onto the document.

Please refer to FIG. 1A and FIG. 1B. A housing 12 covers the principal parts of a scanner 10. A transparent platform 14 is positioned on the housing 12 for a document to be placed on. The housing 12 comprises a track 18 positioned inside the housing 12 parallel with a scanning direction A1 of the scanner 10. The housing also comprises a scanning module 20 installed on and able to slide on the track 18 for sensing the light generated from a light-distributing device 16 passing through a transparent document 17, and for generating a corresponding scan signal. Users can use the light-distributing device 16 as a light source to scan the document 17 with the help of an auxiliary frame 15. The conventional frame 15 has a scanning opening 13A and a light-calibrating opening 13B. Both openings of the frame 15 allow light to pass through, whereas the remaining part of the frame 15 is lightproof. The opening 13A corresponds to the position of the document 17.

The operation of the scanner 10 when scanning a transparent document is as follows. Please refer to FIG. 1B. The light-distributing device 16 is placed on top of the frame 15. The document 17 is placed accordingly into the opening 13A. A light 19, generated by the light-distributing device 16, passes through the document 17, opening 13A, platform 14, and finally projects onto the module 20. The module 20 transforms the received light into digital information.

According to the previous description, the module 20 cannot sense any image information of the document 17 until the light 19 generated from the light-distributing device 16 has projected onto the module 20. If the light-distributing device 16 cannot generate light evenly, the module 20 cannot accurately sense the image information of the document 17 and scanning errors occur.

Please refer to FIG. 2. The scanning module 20 comprises a plurality of sensors 22 (4 sensors numbered from 22a to 22d are depicted as an example) for sensing the light projecting onto the module 20 and then generating corresponding pixel-scan-signals. A scan signal of the module 20 is formed by a combination of pixel-scan-signals of the sensors 22a to 22d. A combination of different scan signals is generated by the module 20 moving along the track 18 and forms the complete image information of the document 17. When the module 20 is moving along the corresponding opening 13A, a light 24 generated from the light-distributing device 16 penetrates the document 17 and projects onto each sensor of the module 20. For example, when the module 20 moves to a position P4, a pixel-scan-signal D41 is generated by the sensor 22a and represents the intensity of light sensed by the sensor 22a.Similarly, the sensor 22d senses the light generated by the light-distributing device 16, passing through an area R44 and projecting onto the module 20, and generates a pixel-scan-signal D44. When the module 20 moves to the position P4, a combination of the four pixel-scan-signals, D41 to D44, forms a scan signal 204. The signal 204 represents the image information of one row (A2 direction) of the document 17 placed on the scanning opening 13A. When the module 20 moves to a position P3, the sensor 22a senses the light passing through an area R31 and then generates a pixel-scan-signal D31. Likewise, the sensor 22d senses the light passing through an area R34 and generates a pixel-scan-signal D34. Combining all the pixel-scan-signals of each sensor while the module 20 is positioned at P3 forms a corresponding scan signal 203. As a result, when the module 20 moves along the track 18 across positions P1 to P4, the respective scan signals 201 to 204 are generated. A combination of the above scan signals forms scanned image information of the document 17.

However, as mentioned previously, the light generated from the light-distributing device 16 is not evenly distributed. In other words, the intensity of the light projecting onto different areas of the platform 14 varies. Please refer to FIG. 2 again. For example, the intensity of light projecting onto an area R41 is stronger than that projecting onto an area R44. Thus, even if the actual images of the document 17 in the areas R41 and R44 are identical, the pixel-scan-signals D41 and D44 are different because of the different intensities of light projecting onto these two areas. Therefore, scanning errors occur. That is, an uneven distribution of light generated from the light-distributing device 16 causes an inconsistency in the image information between the original document and the scanned one.

The opening 13B, included in the frame 15, is used to correct the abovementioned scanning errors(refer to FIG. 1A and FIG. 1B). The operation of the scanner 10 while calibrating the light generated from the light-distributing device 16 is illustrated as follows. It is important that no document is placed on the opening 13B. The module 20 moves to a position P0 under the opening 13B. Each sensor of the module 20 senses the projected light and generates a corresponding pixel-calibration-signal. Each calibration signal is converted into a corresponding correction factor after comparison to a standard value.

As shown in FIG. 2, a correction factor g1 corresponds to the sensor 22a,factor g4 corresponds to the sensor 22d, and so on. Because no document is placed in the opening 13B when the scanner 10 is calibrating light, the light sensed by each sensor of the module 20 positioned at P0 is that which is directly generated from the light-distributing device 16. If the amplitude of the pixel-calibration-signal generated by each sensor is different, the light generated from the light-distributing device 16 is unevenly distributed. If the pixel-calibration-signal generated by a sensor is stronger than the standard value, the intensity of the light projecting onto the corresponding area is too strong and the corresponding correction factor will be smaller than 1. On the contrary, if the pixel-calibration-signal generated by a sensor is weaker than the standard value, the intensity of light projecting onto the corresponding area is too weak and the corresponding correction factor will be larger than 1. The pixel-calibration-signal will approach the standard value after being multiplied by the correction factor. The pixel-calibration-signal generated by each sensor corresponds to a particular correction factor. For example, the correction factors g1 to g4 correspond to the sensors 22a to 22d, respectively.

The prior art method for calibrating a scan signal employs multiplying a pixel-calibration-signal by the corresponding correction factor to form a calibrated scan signal. As shown in FIG. 2, the respective pixel-scan-signals D11 to D14 of the scan signal 201, corresponding to the sensors 22a to 22d, multiplied by the corresponding correction factors g1 to g4 form a calibrated scan signal 301. Similarly, the pixel-scan-signals D21 to D24 of the scan signal 202 multiplied by the corresponding factors g1 to g4 form a calibrated scan signal 302. Likewise, the pixel-scan-signals generated by each sensor of the scan signals 203, 204 are multiplied by a corresponding correction factor to generate calibrated scan signals 303, 304.

The conventional calibration principle assumes that the unevenly distributed light generated by the light-distributing device 16 and projecting through the opening 13B has the same distribution as the unevenly distributed light projecting through the opening 13A. For example, the prior art assumes that the distribution of light generated by the light-distributing device 16 and projecting onto the area R04 of the calibrating opening 13B is the same as that light projecting onto the areas R34 and R44. This results in the pixel-calibration-signal and the corresponding correction factor g4, generated by the sensor 22d when positioned at the area R04 of the opening 13B, being used to calibrate the pixel-scan-signal generated by a sensor when positioned at the areas R34 and R44. If a pixel-calibration-signal generated by the sensor 22d is weak (weaker than the standard value), the pixel-scan-signal generated by the sensor 22d when positioned at the areas R34 and R44 will be amplified by the same correction factor g4. However, the intensity of the light generated by the light-distributing device 16 varies not only along the A2 direction, but also along the A1 direction. In other words, the intensity of the light generated by the light-distributing device 16 and projecting onto the areas R34 and R44 is different. The prior art does not calibrate for this variation of light intensity. Moreover, even if an uneven distribution of light only occurs along the A2 direction, the pattern of the unevenly distributed light projected at the opening 13b is not guaranteed to be identical to that at the opening 13A. The prior art cannot completely solve the problem of uneven light distribution while the scanner 10 is scanning a document along the A1 direction.

### SUMMARY OF INVENTION

It is therefore an objective of the claimed invention to provide a method for calibrating two-dimensional light inhomogeneity of a light-distributing device of a scanner to solve the problems of the conventional method of only calibrating one-dimensional light inhomogeneity.

According to the claimed invention, a scanner includes a housing having a transparent platform positioned on the housing for placing a document, a light-distributing device positioned above the transparent platform for projecting light on the document placed on the transparent platform, a track positioned inside the housing parallel with a scanning direction of the scanner, and a scanning module movably positioned on the track for sensing the light passing through the document and generating a corresponding scan signal. The method includes amplifying or decaying the scan signal generated from the scanning module according to a position of the scanning module located on the track when the scanning module slides along the track to scan the document.

It is an advantage of the claimed invention that the method can calibrate the scan signal of the document in two dimensions. The claimed invention can be used to detect when a light-emitting cell of the light-distributing device has malfunctioned. The claimed invention can use a different method to generate a common correction factor so as to save memory space in a computer.

### BRIEF DESCRIPTION OF DRAWINGS

FIG. 1A is a pictorial view of a conventional scanner.

FIG. 1B is a cross-sectional view of the scanner 10 in FIG. 1A scanning a transparent document.

FIG. 2 is a schematic diagram illustrating a prior art method of calibrating an uneven light distribution.

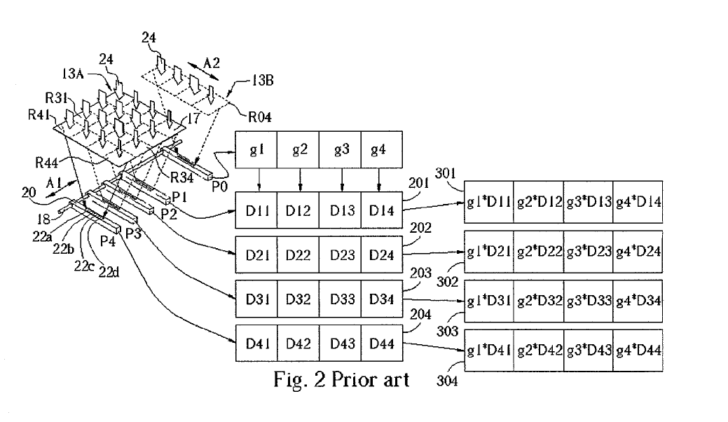

FIG. 3 is an exploded perspective view of a scanner according to the invention.

FIG. 4 is a schematic diagram illustrating a method of calibrating for an uneven light distribution according to the invention.

FIG. 5 is a schematic diagram of a second embodiment illustrating a method for calibrating for an uneven light distribution.

FIG. 6 is a schematic diagram of a third embodiment illustrating a method for calibrating for an uneven light distribution.

### DETAILED DESCRIPTION

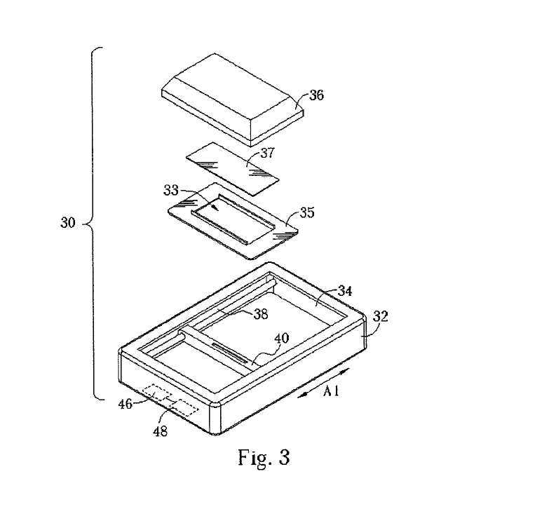

Please refer to FIG. 3. A housing 32 covers the principal parts of a scanner 30. The scanner 30 comprises a transparent platform 34 positioned on the housing 32 for a document to be placed on. A scanning module 40 is installed on and able to slide on a track 38 and can move along an A1 direction for scanning a document. The scanner 30 also comprises a processor 46 for controlling the operation of the scanner 30 and a storing circuit 48 for storing the information necessary for the scanner 30 to function. The scanner 30 includes a light-distributing device 36 and an auxiliary frame 35 to scan a transparent document 37, such as a projection transparency. The light-distributing device 36 is used to project light when the scanner 30 is scanning the document 37. The document 37 is placed on a light-penetrable scanning opening 33 positioned in the central part of the frame 35. When the light-distributing device 36 is placed upon the frame 35, the light generated from the light-distributing device 36 projects through the document 37, penetrates through the opening 33 and the platform 34, and is finally sensed by the module 40.

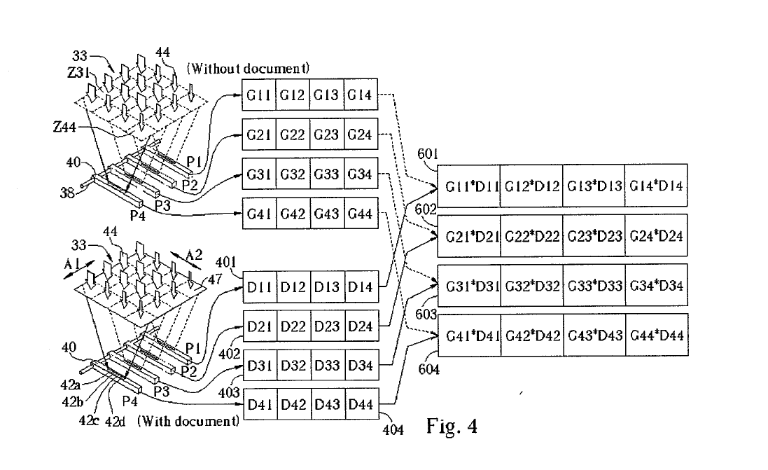

Please refer to FIG. 4. Similar to the prior art scanner, the module 40 has a plurality of sensors (only four sensors 42a to 42d, as shown in FIG. 4, are used as an example). The light penetrating through areas positioned along an A2 direction of the opening 33 projects onto different sensors and then these sensors generate corresponding pixel-scan-signals. A combination of the pixel-scan-signals generated by each sensor forms a scan signal. The scan signal represents a row (A2 direction) image of a document 47. When the module 40 moves from one end of the scanner 30 to the other end, along the track 38 in the direction A1, a combination of the scan signals formed at different positions forms a complete image signal of the document 47. Scan signals 401 through 404, shown in FIG. 4, are respectively representative of when the module 40 is positioned at positions P1 through P4. The pixel-scan-signals D41 to D44 of the scan signal 404, for example, represent the corresponding signals generated by the sensor 42a to 42d when the module 40 is positioned at the position P4.

Unevenly distributed light generated by the light-distributing device 36 causes an image to be scanned inaccurately. To calibrate for this inaccuracy, the scanner 30, according to the invention, scans the opening 33 completely without a document being placed on the opening 33 and generates corresponding pixel-scan-signals and scan signals. Each of these pixel-scan-signals and scan signals are in effect pixel-calibration-signals and calibration signals. Because no document is placed on the opening 33, the light sensed by the module 40 is the light directly generated by the light-distributing device 36 and projected onto the module 40. A correction factor can thus be generated, according to the invention, by determining the corresponding pixel-calibration-signal generated by each sensor when the module 40 is positioned at a different position. For example, the module 40 is positioned at the position P3. If a pixel-calibration-signal, generated by the sensor 42a,is stronger than a standard value, the intensity of the light projected onto an area Z31 is too strong and a correction factor G31 with a value smaller than 1 is generated. Similarly, if the module 40 is positioned at the position P4 and a pixel-calibration-signal, generated by a sensor 42d, is weaker than the standard value, the intensity of the light projected onto an area Z44 is too weak and another correction factor G44 with a value greater than 1 is generated. The result of multiplying the correction factor by the corresponding pixel-calibration-signal will approach the standard value. In other words, when the scanning module 40 is positioned at the position P1, the correction factors G11 to G14 can be generated by determining the corresponding pixel-scan-signal generated by each sensor 42a to 42d. Generally, different correction factors can be generated by determining different pixel-calibration-signals generated by each sensor no matter what position the module 40 is at.

The embodiment method to calibrate a scan signal is described as follows. Pixel-scan-signals D11 through D14, generated by the corresponding sensors when the module 40 is positioned at the position P1 are multiplied by the corresponding correction factors G11 through G14 (the corresponding correction factor of each pixel-calibration-signal when the module 40 is positioned on the position P1) to generate a calibrated scan signal 601. Similarly, pixel-scan-signals D41 through D44 of the signal 404 are multiplied by the corresponding correction factors G41 through G44 to generate calibrated scan signal 604. The signalsand 403 are also thus modified by the corresponding correction factors tocalibrated scan signals 602 and 603. In this way, the scanner 30 is calibrated for the inaccuracy caused by unevenly distributed light generated by the light-distributing device 36.

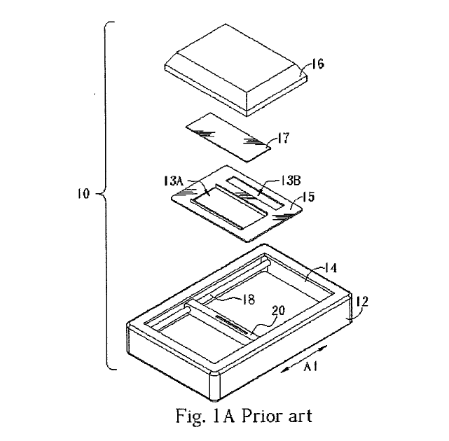

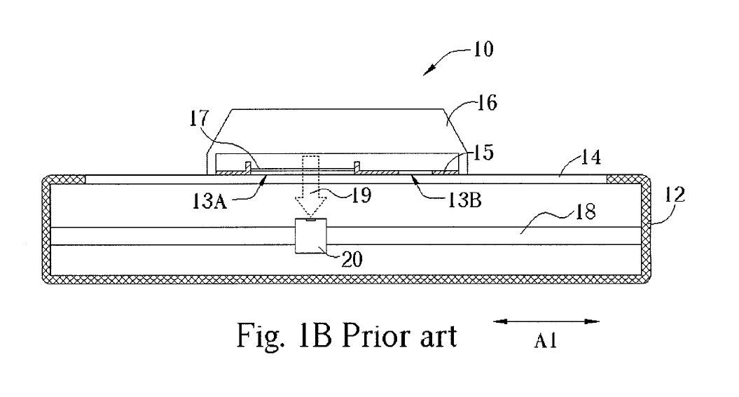

In contrast to the prior art, the correction factors are generated by sensors sensing the light passing through the opening 33 rather than through the opening 13B (shown in FIG. 1A). The invention calibration method uses different correction factors to calibrate the pixel-scan-signals generated at different positions so that the scanned image is corrected not only in the A2 direction but also in the A1 direction. This is superior to the prior art method of only calibrating the scanner in the A2 direction.

In practical application, the invention method determines the correction factors by only scanning the opening 33 once while no document is present on the platform 34, and then stores these correction factors in the storing circuit 48. The scanner 30 will calibrate a scanned document according to the correction factors stored in the circuit 48. Another user can use these correction factors to calibrate another scanned document. Usually, a scanner is connected to a computer and an application stored on the computer controls the scanner. In such a circumstance, a hard disk or other memory device of the computer stores the application and the correction factors to correct the original scan signals. Additionally, because the light distribution of a scanner may change over time, the application can remind a user to update the correction factors by repeating the described calibration procedure.

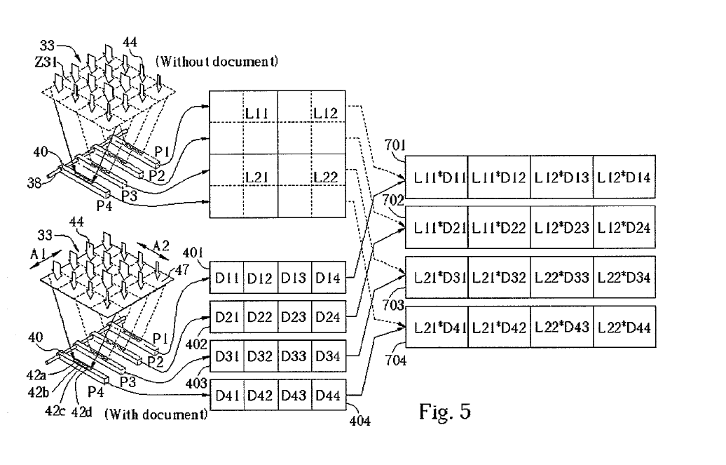

The correction factors can also be generated by the following method. Please refer to FIG. 5. The difference between this embodiment and the former one is that correction factors L11, L12, L21, and L22 are generated according to pixel-calibration-signals generated by corresponding sensors when the module 40 moves to different positions. For example, the factor L11 is generated according to four pixel-calibration-signals generated by the sensors 42a, 42b when the module 40 moves to the positions P1, P2. Averaging these four pixel-calibration-signals and dividing the average by a standard value can generate the corresponding correction factor L11. The correction factor L12 can be generated in a similar way using the sensors 42c, 42d. Multiplying the pixel-scan-signals generated by the sensors 42a to 42d while the module 40 moves across the positions P1, P2 by the corresponding correction factors L11, L12 generates calibrated scan signals 701, 702. In a similar manner, the factors L21, L22 can be used to generate calibrated scan signals 703, 704, as shown in FIG. 5. The advantage of this embodiment is that the memory required for storing the correction factors is smaller because the number of correction factors is reduced. In addition, some light-distributing devices project evenly distributed light within a small area, so using an averaged correction factor will not impact scanning quality. Of course, in practical application, users can use as many pixel-scan-signals as desired multiplied by a common correction factor to generate a calibrated scan signal. Users can also select the pixel-calibration-signals generated by different sensors while the module 40 moves to different positions to generate another common correction factor.

The number of pixel-scan-signals used for generating a common correction factor can be changed according to different sensors and different scanning positions. Please refer to FIG. 5 again. For example, nine pixel-calibration-signals, generated by the three sensors 42a to 42c while the module 40 moves across the three positions P1 to P3, could be used to generate the common correction factor L11 for calibrating pixel-scan-signals D11-D13, D21-D23, and D31-D33. Only three pixel-calibration-signals, generated by the sensors 42a to 42c after the scanning module 40 moves to the position P4, would then be used to generate the common correction factor L21. Alternately, six pixel-calibration-signals, generated by the sensor 42a to 42c while the module 40 moves across the positions P3 and P4, could also be used to generate the common correction factor L21. Because some light-distributing devices generate evenly distributed light from a central portion but unevenly distributed light from a peripheral portion, the method of using different numbers of pixel-calibration-signals to generate common correction factors can save memory space in a computer.

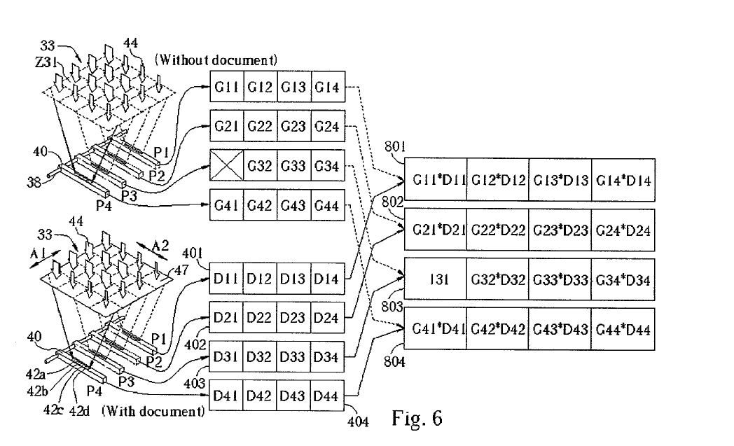

Please refer to FIG. 6. Some light-distributing devices are formed by a plurality of light-emitting cells disposed on the light-distributing device. Occasionally a light-emitting cell of the light-distributing device malfunctions, and thus the light generated by the device is unevenly distributed. A user can determine which light-emitting cell has malfunctioned by utilizing the present invention. For example, if a pixel-scan-signal generated by a sensor 42a while the scanning module moves to a position P3 is weaker than a threshold value, a light-emitting cell disposed on a light-distributing device corresponding to an area Z31 is judged to have malfunctioned. In such a circumstance, the result of calibrating the scan signal by a correction factor is not adequate. Instead, an interpolation method using the pixel-scan-signals generated by the neighboring sensors while the scanning module moves to the neighboring positions is used to calibrate the pixel-scan-signal. In this example, a pixel-scan-signal 131of a calibrated scan signal 803 at the corresponding area Z31 can be generated by interpolating pixel-scan-signals D21, D22, D32, D42, and D41. The remaining pixel-scan-signals of the scan signal can be calibrated by the method mentioned in the first embodiment of the invention to generate corresponding pixel-scan-signals of the calibrated scan signals 801 to 804.

Additionally, the light-distributing device of some scanners generates light of different colors. Each color of light generates corresponding scanned image information, which is then combined to form a full color scanned image. The method of the invention can also generate different correction factors according to different colored light of a color image. These correction factors can be used to calibrate the corresponding color of light of the color image.

In summary, the method for calibrating light of the invention first uses a scanning module of a scanner to scan an opening while no document is placed on a transparent platform, and then utilizes a corresponding method of calibration, such as determining correction factors. When the scanner scans a document, it can use the correction factors to calibrate the document so the image quality is improved. In contrast to the prior art, the invention can calibrate a document image in two dimensions, not just in one dimension. Furthermore, the auxiliary frame 35 of the invention does not comprise a calibrating opening (refer to FIG. 1A and FIG. 1B according the prior art, and FIG. 3 according to the invention), so the area covered by the light-distributing device is decreased resulting in the cost of manufacturing the scanner being decreased.

Following the detailed description of the invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for calibrating an image generated from a scanner when scanning a document, the scanner comprising:
a housing comprising a transparent platform positioned on the housing for placing the document thereon;
a light-distributing device positioned above the transparent platform for projecting light on the document;
a track positioned inside the housing parallel with a scanning direction of the scanner; and
a scanning module movably positioned on the track for sensing the light passing through the document and generating a corresponding scan signal;
the method comprising:
amplifying or decaying the scan signal generated from the scanning module according to a position of the scanning module located on the track when the scanning module slides along the track to scan the document.

2. The method of claim 1 further comprising:
moving the scanning module along the track for sensing the light, which is generated from the light-distributing device and passes through the transparent platform, and generating a corresponding calibration signal when no document is positioned on the transparent platform; and
using the calibration signal, which is generated from the scanning module moving to a first position on the track without the document positioned on the transparent platform, to amplify or decay the scan signal when the document is positioned on the transparent platform to be scanned and when the scanning module reaches the first position on the track to scan the document.

3. The method of claim 2 wherein the scan signal is amplified by a correction factor when the scan signal is weaker than a standard value, and the scan signal approaches the standard value after being amplified by the correction factor.

4. The method of claim 2 wherein the scan signal is decayed by a correction factor when the scan signal is stronger than a standard value, and the scan signal approaches the standard value after being decayed by the correction factor.

5. The method of claim 2 further comprising recording the calibration signal.

6. The method of claim 1 wherein the scanning module comprises a plurality of sensors, and each sensor is used for sensing the light projecting on the scanning module to generate a corresponding pixel-scan-signal so that the scan signal generated from the scanning module comprises a plurality of pixel-scan-signals generated from the sensors;
the method further comprising:
amplifying the pixel-scan-signal generated from one of the sensors with corresponding correction factor when the pixel-scan-signal is weaker than a standard value; and
decaying the pixel-scan-signal generated from one of the sensors with corresponding correction factor when the pixel-scan-signal is stronger than the standard value.

7. The method of claim 6 further comprising:
moving the scanning module along the track for sensing the light, which is generated from the light-distributing device and passes through the transparent platform, and each sensor generating a corresponding pixel-calibration-signal when no document is positioned on the transparent platform; and
determining the correction factor of the pixel-scan-signal, which is generated from the scanning module scanning the document at a first position on the track, according to the corresponding pixel-calibration-signal generated from the sensor of the scanning module located at the first position on the track when no document is positioned on the transparent platform.

8. A scanner comprising:
a housing comprising a transparent platform positioned on the housing for placing a document thereon;
a light-distributing device positioned above the transparent platform for projecting light on the document;
a track positioned inside the housing parallel with a scanning direction of the scanner;
a scanning module movably positioned on the track for sensing the light passing through the document and generating a corresponding scan signal; and
a processing circuit for controlling the scan signal;
wherein the processing circuit amplifies or decays the scan signal according to a position of the scanning module located on the track when the scanning module slides along the track to scan the document.

9. The scanner of claim 8 wherein the scanning module moves along the track for sensing the light, which is generated from the light-distributing device and passes through the transparent platform, and generates a corresponding calibration signal when no document is positioned on the transparent platform, and the processing circuit uses the calibration signal, which is generated from the scanning module moving to a first position on the track without the document positioned on the transparent platform, to amplify or decay the scan signal when the scanning module moves to the first position on the track for scanning the document which is positioned on the transparent platform.

10. The scanner of claim 9 wherein the processing circuit amplifies the scan signal by an correction factor when the scan signal is weaker than a standard value, and the scan signal approaches the standard value after being amplified by the correction factor.

11. The scanner of claim 9 wherein the processing circuit decays the scan signal by a correction factor when the scan signal is stronger than a standard value, and the scan signal approaches the standard value after being decayed by the correction factor.

12. The scanner of claim 9 further comprising a recording circuit for storing the calibration signal.

13. The scanner of claim 9 being connected to a computer, and the calibration signal being stored in the computer.

14. The scanner of claim 8 wherein the scanning module comprises a plurality of sensors, each sensor is used for sensing the light projecting on the scanning module to generate a corresponding pixel-scan-signal, the scan signal generated from the scanning module comprises a plurality of the pixel-scan-signals generated from the sensors, and the processing circuit amplifies and decays pixel-scan-signals generated from different sensors with corresponding correction factors after comparing the pixel-scan-signals with a standard value.

15. The scanner of claim 14 wherein the scanning module moves along the track for sensing the light which is generated from the light-distributing device and passes through the transparent platform, uses each sensor for generating a corresponding pixel-calibration-signal when no document is positioned on the transparent platform, and the processing circuit determines the correction factor of the pixel-scan-signal, which is generated from the scanning module scanning the document at a first position on the track, according to the corresponding pixel-calibration-signal generated from the sensor of the scanning module located at the first position on the track when no document is positioned on the transparent platform.
